(19) United States
(12) Patent Application Publication
(10) Pub. No.: US 2002/0181830 A1
(43) Pub. Date: Dec. 5, 2002

(54) Method for making all-fiber interleaver with continuous fiber arm

(76) Inventors: Jyh Ren Dent, Rolling Heights, CA (US); Amado Cordova, Venice, CA (US); Ronald J. Michal, Wrightwood, CA (US); Chin L. Chang, Walnut, CA (US); Trong-Huang Lee, Walnut, CA (US)

Correspondence Address: ELLIOTT N. KRAMSKY, Esq., Suite 400, 5850 Canoga Avenue, woodland Hills, CA, 91367, US

(21) Appl. No.: 09/861,910

(22) Filed: May 21, 2001

(51) Int. Cl. G02B 6/26

(52) U.S. Cl. 385/15

(57) ABSTRACT

A method for forming an all-fiber, low-loss interleaver to obtain a predetermined optical channel spacing. The interleaver features at least one arm formed with and continuous between couplers of a Mach Zender type arrangement. The interleaver is formed by first analytically determining Δθ, the difference in optical lengths between the two optical paths between the couplers. The difference is then fine-tuned by the application of heat and tension to a jacket-stripped segment of the continuous fiber arm as a DWDM signal is observed at the output of the interleaver.

### BACKGROUND

1. Field of the Invention

The present invention relates to optical communication networks. More particularly, this invention pertains to a method for fabricating an all-fiber interleaver of low insertion loss and with precise optical channel spacing.

2. Description of the Prior Art

The current and projected growth of the Internet has led to readily foreseeable demands for increased bandwith to service both consumers and businesses, both domestic and outside the United States. An accepted method for addressing the bandwidth and cost demands of rapidly-proliferating networks and connections has been the integration of optical elements into such networks.

Optical fiber, due to its relatively high bandwidth and low cost is the preferred means for transmission of voice and data at rates greater than a few tens of megabits per second and over distances of greater than a kilometer. In view of vast increases in projected demand, future network development must take advantage of devices and arrangements that are capable of enhancing traffic many times over without commensurate increases in materials (e.g. optical fiber) and other costs.

Cost per bit per mile (cost of transporting data traffic to a user) is a critical measure of cost effectiveness in communications networks. This may be improved by increasing transmission distance (through the use of such technologies as Raman or erbium-doped fiber amplification) or the number of bits carried (e.g., by employing higher bit rates in a single wavelength in addition to utilizing time division multiplexing).

Another approach to enhancing the cost effectiveness of network designs relies upon the improvement of component performance to increase the number of wavelength channels. The extension of the number of wavelength channels, while maintaining channel spacing, requires the development of new amplifier designs due to the need to increase wavelength range. Further bandwidth enhancement may be obtained through the development of devices compatible with reduced channel spacing.

Reductions in channel spacing place increased performance requirements upon optical filters. Currently, major filtering technologies include thin-film filters, arrayed waveguide gratings and fiber Bragg gratings. Each faces technological challenges in adapting to reduced channel spacings. Thin-film filters, while satisfactory for 400 and 200 GHz dense wavelength division multiplexing (DWDM) systems, are difficult to adapt to channel spacings of 100 and 50 GHz with acceptable yields. A large number of Bragg gratings is required for narrow filter passbands as a single device is required to separate one wavelength. Thus, scaling to a high channel count requires numerous devices. Further, while they are easily coupled to a fiber, expensive circulators are required as they reflect the filtered wavelength to the input fiber.

Arrayed waveguide gratings (AWG), currently commercially available for 40 channels with 100 GHz spacings, can readily separate a spectrum of wavelengths into individual channels. Design and manufacturing tolerances complicate the manufacture of arrayed waveguide gratings as channel spacing decreases. The cost and insertion loss of AWG's with more than 40 channels are extremely high.

The interleaver is a device that combines two input sets of wavelengths in which the channels of one set of wavelengths are offset by one half the channel spacing from those of the other set. Such device is ideal for ultra dense networks. Further, interleavers can work in reverse to separate a single densely packed channel set into two output fibers, each of twice the channel spacing of the original set. Interleavers may be cascaded to provide further channel separation on four output fibers, each transmitting one fourth of the number of channels and four times the channel spacing. This allows the use of simpler thin-film filters or arrayed waveguide gratings to separate the individual channels.

Various interleaver configurations have been proposed including liquid crystals, birefringent crystals and others. Interleavers based upon a fused-fiber Mach-Zehnder interferometer are attractive as they offer a simple, cost-effective design. However, careful control of the fiber path length difference between the two arms of the interferometer is essential to obtain the correct channel spacing required to match the device to the International Telecommunications Union (ITU) grid.

### SUMMARY OF THE INVENTION

The present invention overcomes the foregoing shortcomings of the prior art by providing a method for forming an all-fiber optical interleaver of the type that includes a first coupler and a second coupler joined to one another by arms of optical fiber for obtaining a predetermined optical channel spacing.

The method is begun by analytically determining an optical path length difference between a first and a second arm that corresponds to the predetermined optical channel spacing. Thereafter, the first arm is formed of a continuous optical fiber with the first and second couplers so that the optical path length difference between the first and second arms is equal to or less than the analytically-determined path length difference.

The outer jacket is removed from a portion of the continuous fiber intermediate the couplers. An optical signal comprising a plurality of optical channels having the predetermined channel spacing is then input to the interleaver and the output observed. Any difference between the observed optical channel spacing and the predetermined optical channel spacing is corrected by applying heat and tension to that portion of the continuous fiber between locations that lie between the couplers. The process is repeated until the observed output comprises the predetermined optical channel spacing.

The foregoing and additional features and advantages of this invention will become further apparent from the detailed description that follows. Such description is accompanied by a set of drawing figures. Numerals of the drawing figures, corresponding to those of the written description, point to the features of the invention with like numerals referring to like features throughout both the written description and the drawings.

### BRIEF DESCRIPTION OF THE DRAWINGS

FIG. 1 is a schematic view of an all fiber optical interleaver;

FIG. 2 is a logarithmic vertical scale graph of normalized output power as a function of optical frequency for an all-fiber interleaver based upon the Mach Zender interferometer;

FIGS. 3(a) and 3(b) illustrate an interleaver in accordance with the invention and a schematic diagram of the setup for obtaining a predetermined optical channel spacing by adjusting Δθ in accordance with the method of the invention; and

FIG. 4 is a flow diagram of the method of the invention.

### DETAILED DESCRIPTION OF THE PREFERRED EMBODIMENT

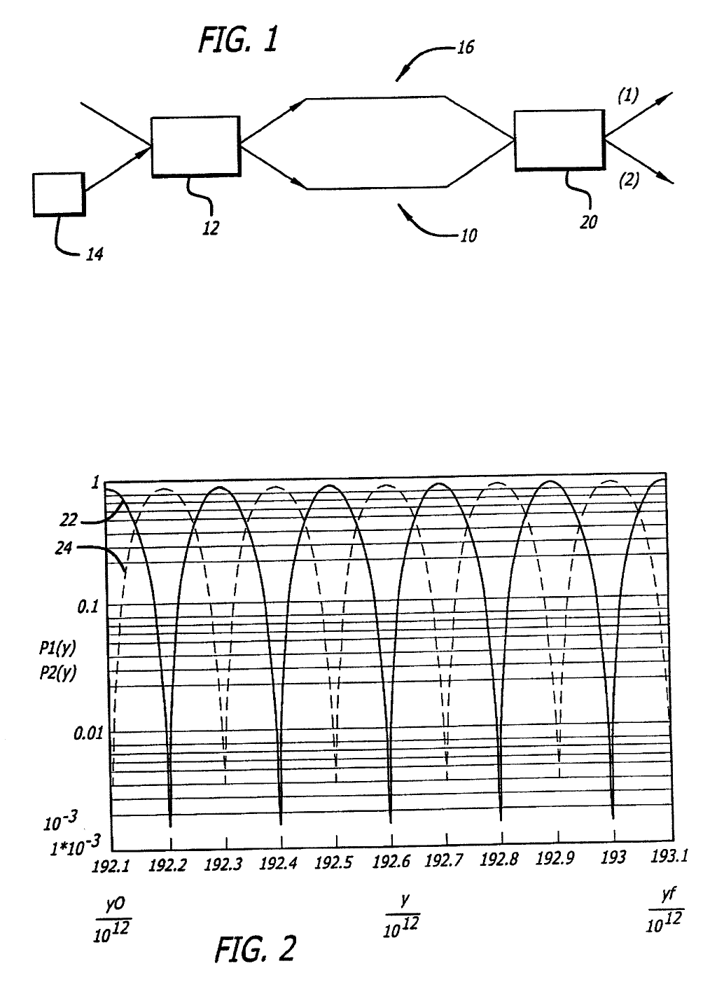

FIG. 1 is schematic view of an interleaver 10 in accordance with the invention. Such a device operates upon an interferometric principle and the analysis that follows is applicable to a number of two-beam interferometric interleavers including all-fiber Mach Zender and birefringent plates.

The interleaver 10 comprises a first coupler 12 for splitting light from a source 14 into two beams. A first optical fiber path 16 comprises a first arm of the interferometer and a second optical fiber path 18 comprises the second arm of the interleaver 10. The optical paths 16 and 18 terminate at a second coupler 20. The couplers 12 and 20 are fused biconical couplers fabricated by biconical tapered fusion technology processes well-known to those skilled in the art. Each coupler comprises a pair of optical fibers that have been stripped of their outer jackets and carefully cleaned. The claddings of the glass fibers are held in contact, heated to melting temperature and tension applied to reduce the thickness in the region of contact. At this point, the cores of the fibers (each about 9 microns in diameter) are very closely spaced to thereby achieve optical coupling between the two fiber cores. The resultant device is commonly encapsulated in a quartz tube. Through the phenomenon of evanescent coupling, light traveling through the core of one fiber is coupled into the core of the other fiber to result in “splitting” of the optical signal. A coupler may act in reverse to combine the light traveling through the two fibers into a single fiber, thus acting as a “combiner”. In FIG. 1, the coupler 12 acts as a splitter while the coupler 20 acts as a combiner.

Propagation of light through the different components of the interleaver 10 can be analyzed in a matrix format with each matrix having two columns and two rows in correspondence to each element of the interleaver 10 possessing two inputs and two outputs. The inputs and outputs are complex representations of the optical electric field (monochromatic light assumed).

Frequency Response of Interleaver

The propagation matrices for the (splitter) coupler 12, the optical paths 16, 18 and the (combiner) coupler 20 are as follows:

$$[ \begin{matrix}\sqrt{α} & \sqrt{1 - α} \cdot {ⅇ}^{ⅈ \cdot \frac{π}{2}} \\ \sqrt{1 - α} \cdot {ⅇ}^{ⅈ \cdot \frac{π}{2}} & \sqrt{α}\end{matrix} ] ⌈ \begin{matrix}{ⅇ}^{ⅈ \cdot φ1 - δ1} & 0 \\ o & {ⅇ}^{ⅈ \cdot φ2 - δ2}\end{matrix} ⌉ [ \begin{matrix}\sqrt{β} & \sqrt{1 - β} \cdot {ⅇ}^{ⅈ \cdot \frac{π}{2}} \\ \sqrt{1 - β} \cdot {ⅇ}^{ⅈ \cdot \frac{π}{2}} & \sqrt{β}\end{matrix} ] \qquad ( 1 )$$

Where:

α, β are the power splitting ratios of the couplers 12 and 20 respectively;

φ1, φ2 are the phase shifts through the optical paths 16 and 18 respectively; and

δ1, δ2 are the amplitude loss coefficients of optical paths 16 and 18 respectively.

The matrix MI for the interleaver 10 is the product of the three matrices, namely

$$\text{MI} \text{:} = [ \begin{matrix}\sqrt{α \cdot β \cdot } {ⅇ}^{ⅈ \cdot φ1 - δ1} - \sqrt{( 1 - α ) \cdot ( 1 - β )} \cdot {ⅇ}^{ⅈ \cdot φ2 - δ2} & \sqrt{β \cdot ( 1 - α )} \cdot {ⅇ}^{ⅈ \cdot ( \frac{π}{2} + φ1 ) - δ1} + \sqrt{α \cdot ( 1 - β )} \cdot {ⅇ}^{ⅈ \cdot ( \frac{π}{2} + φ2 ) - δ2} \\ \sqrt{α \cdot ( 1 - β )} \cdot {ⅇ}^{ⅈ \cdot ( \frac{π}{2} + φ1 ) - δ1} + \sqrt{β \cdot ( 1 - α )} \cdot {ⅇ}^{ⅈ \cdot ( \frac{π}{2} + φ2 ) - δ2} & \sqrt{α \cdot β} \cdot {ⅇ}^{ⅈ \cdot φ2 - δ2} + \sqrt{( 1 - α ) \cdot ( 1 - β )} \cdot {ⅇ}^{ⅈ \cdot φ1 - δ1}\end{matrix} ] \qquad ( 2 )$$

The complex output electric fields EO1, EO2 are derived from the input electric fields EI1, EI2 using

$$[ \begin{matrix}EO1 \\ EO2\end{matrix} ] \text{:} = MI \cdot [ \begin{matrix}EI1 \\ EI2\end{matrix} ] \qquad ( 3 )$$

An ideal interleaver has power splitting ratios of 0.5 for both of the couplers 12, 20 (α, β=½) with small and equal losses for both of the optical paths 16, 18 (δ1=δ2=δ<<1). The matrix for the ideal interleaver is (substituting i=exp(i π/2)

$$\text{MI} \text{:} = \frac{1}{2} \cdot {ⅇ}^{- δ} \cdot [ \begin{matrix}{ⅇ}^{ⅈ \cdot φ1} - {ⅇ}^{ⅈ \cdot φ2} & i \cdot ( {ⅇ}^{ⅈ \cdot φ1} + {ⅇ}^{ⅈ \cdot φ2} ) \\ i \cdot ( {ⅇ}^{ⅈ \cdot φ1} + {ⅇ}^{ⅈ \cdot φ2} ) & {ⅇ}^{ⅈ \cdot φ2} - {ⅇ}^{ⅈ \cdot φ1}\end{matrix} ] \qquad ( 4 )$$

Optical Interleaver as Splitter of a Multi-Wavelength Signal

Considering first the ideal interleaver, using equations 2 and 3 and setting EI1=EI (a real number) and EI2=0, the optic electric field outputs are

$$EO1 \text{:} = \frac{1}{2} \cdot {ⅇ}^{- δ} \cdot ( {ⅇ}^{ⅈ \cdot φ1} - {ⅇ}^{ⅈ \cdot φ2} ) \cdot EI EO 2 \text{:} = \frac{1}{2} \cdot {ⅇ}^{- δ} \cdot i \cdot ( {ⅇ}^{ⅈ \cdot φ1} + {ⅇ}^{ⅈ \cdot φ2} ) \cdot EI \qquad ( 5 )$$

The optical power at output port 1 is

$${[ EO1 ]}^{2} {=}^{\frac{{ⅇ}^{- 2 δ}}{4} \cdot [ 1 + 1 - {ⅇ}^{ⅈ \cdot ( φ1 - φ2 )} - {ⅇ}^{- ⅈ \cdot ( φ1 - φ2 )} ]} or \\ P1 := {ⅇ}^{- 2 δ} \frac{1 - cos ( Δφ )}{2} \qquad ( 6 )$$

The optical power at output port 2 is

$${[ EO2 ]}^{2} {=}^{\frac{{ⅇ}^{- 2 δ} \cdot ( 1 )}{4} \cdot [ 1 + 1 + {ⅇ}^{ⅈ \cdot ( φ1 - φ2 )} + {ⅇ}^{- ⅈ \cdot ( φ1 - φ2 )} ]} or \\ P2 \text{:} = {ⅇ}^{- 2 δ} \frac{1 + cos ( Δφ )}{2} \qquad ( 7 )$$

For a non-ideal interleaver, the equations for the output powers are (from P1=|EO1|² and P2=|EO|²) as follows:

P1: =α·β·e^{-δ1}+(1−α)·(1−β)·e^{-δ2}−2·\sqrt{α·β·(1−α)·(1−β)}·e^{-(δ1+δ2)}·cos (Δφ)

P2: =α·(1−β)·e^{-δ1}+β·(1−α)·e^{-δ2}+2·\sqrt{α·β·(1−α)·(1−β)}·e^{-(δ1+δ2)}·cos (Δφ)

FIG. 2 is a plot of the interleaver's frequency response, namely, the normalized output power versus optical frequency (in THz) as defined by the preceding equations for an all-fiber interleaver based upon the principle of the Mach-Zender interferometer having the following parameters: α=0.51, β=0.49 (power splitting ratios); L1=0.25 dB, L2=1.0 dB (optical power loss of paths 16, 18 in dB, related to amplitude loss coefficient δ by e^{-2δ}=10^{-L/10}); optical path length difference=1.5 mm. The optical path length difference Δθ is related to the optical phase shift difference Δφ by

Δφ=2πσΔθ/c (9)

Where c is the speed of light in a vacuum and the optical path length θ equals the product of the physical length times refractive index.

The logarithmic plot of FIG. 2 with the output taken at “1” of FIG. 1 indicated by the succession of maxima and minima of the curve denoted 22 and the output taken at “2” of FIG. 1 indicated by the succession of maxima and minima of the curve denoted 24 illustrates a peak-to-peak frequency spacing of a given output of 0.2 THz (200 GHz) with the signals at the two outputs shifted with respect to one another by 0.1 THz (100 GHz). Since a non-zero loss is assumed, the peak amplitudes at the two outputs do not equal 1.0.

The operation of an interleaver as a multi-channel signal splitter can be understood from FIG. 2. Assuming that the input is a series of mutually incoherent wave channels whose frequency bands do not overlap and that are separated by 100 GHz, the interleaver 10 separates adjacent channels as follows: “odd” frequency channels are forwarded to the output 1 of FIG. 1 as constructive interference occurs at this output for such frequencies while “even” frequency channels are forwarded to output 2 for the same reason.

Relationship Between Optical Signal and Path Length Difference

The optical path length difference established between the optical fiber arms 16 and 18 is the primary determinant of the frequency spacing for the interleaver. Since such spacing is established by a telecommunications industry standard, such as the ITU grid, a condition is established upon the optical path length difference between the arms 16 and 18. (It should be noted that, while the all-fiber interleaver 10 is based upon the “generic” Mach-Zender interferometer configuration, a main difference between them being that, in an interferometer, the optical path length difference is generally on the order of one wavelength while that of the inteleaver 10 is typically in the hundreds of wavelengths.)

Assume that the input to the interleaver 10 comprises a DWDM signal consisting of a train of mutually incoherent optical signals (wavelength channels) of central frequencies υ₁, υ₂, υ₃ . . . υ_{M} where M is the number of channels and Δυ the frequency spacing between adjacent channels. Referring back to Equations 6 through 8, constructive interference occurs at output port 2 when the phase difference ΔΦ is a multiple of 2π since cos (2Nπ)=+1. It follows that, for any particular frequency υ₁, the following applies

ΔΦᵢ=2πυᵢΔθ/c=2Nπ (10)

where N is a positive integer that represents the difference between the sizes of the optical paths 16 and 18 in terms of the number of wavelengths that can “fit” within each.

For the interleaver 10 to function, destructive interference must occur for the adjacent optical frequency υᵢ₊₁. It follows that ΔΦᵢ₊₁ must be an odd multiple of π so that cos ((2N+1)n=−1 and the following must also be satisfied

ΔΦᵢ₊₁=2πυᵢ₊₁Δθ/c=(2N+1)π (11)

Equations 10 and 11 imply that the signal at frequency υᵢ₊₂ will see constructive interference and the signal at υᵢ₊₃ will see destructive interference at output 2. Generally, all signals of frequency υᵢ₊ₖ experience constructive interference (maximum intensity) if k is even and destructive interference (minimum intensity) if k is odd. The situation is exactly reversed in regard to the signal appearing at the output 1. Thus, the signals at the outputs 1 and 2 are complementary and the net outcome is that the interleaver 10 splits the input DWDM signal channels, sending the even channels to the output 2 and the odd channels to the output 1.

By subtracting equation 10 from equation 11, the relationship between the optical path length difference and frequency spacing between adjacent input channels, Δυ=υᵢ₊₁−υᵢ can be shown to be

Δθ=c/(2Δυ) (12)

The plot of interleaver 10 response of FIG. 2 assumes a Δθ of 1.5 mm so that the frequency spacing between adjacent channels at the input is 100 GHz (n=1.5). Since the plot corresponds to interleaver outputs, the frequency spacing between adjacent channels of the same output (port 1 or 2) is 200 GHz.

Thus, it can be seen that the optical path length difference, Δθ, traversed by the signals transmitted through the first and second arms 16 and 18 is a very critical factor in the design and fabrication of an all-fiber optical interleaver 10 based generally upon the Mach Zender interferometer in which a pair of fiber couplers 12, 20 are joined by two fiber arms 16, 18. Unfortunately, while it is possible to determine this important parameter analytically with great precision, the manufacture of such a device represents a significant challenge.

Splicing two couplers together to form the interleaver 10 poses numerous difficulties. First, the splicing together of segments of fiber associated with the couplers 12 and 20 suffers from inherent problems of splices, some of which make an interleaver formed of spliced arm impractical for production. Attainment of good splices requires extreme care in residue and dirt removal after jacket stripping. In addition, each splice requires the careful precision cleaving of two fiber ends to optical quality flatness. Imperfections in forming a splice lead to high insertion loss and consequent suboptimal functioning of the device. The main shortcoming of this technique is that, if the splice in one of the two arms of the interleaver has to be redone, a corresponding change, requiring another new splice, must be made in the other arm to maintain the ΔΘ required to achieve the desired channel spacing.

The present invention addresses the above problems by providing a method for forming an all-fiber optical interleaver based upon the Mach Zender interferometer that permits the fabrication of a device of precise channel spacing that is free of splice-related problems in at least one of the interleaver's arms. Such method relies upon the above-mentioned analytical relationship between optical channel spacing and ΔΘ, the optical path length difference experienced by light traveling through the two arms 16, 18 of the device. That is, recognizing that such a relationship exists, the method of the invention permits one to adjust ΔΘ in a controlled manner while observing the output at one of the two outport fibers of the coupler 20.

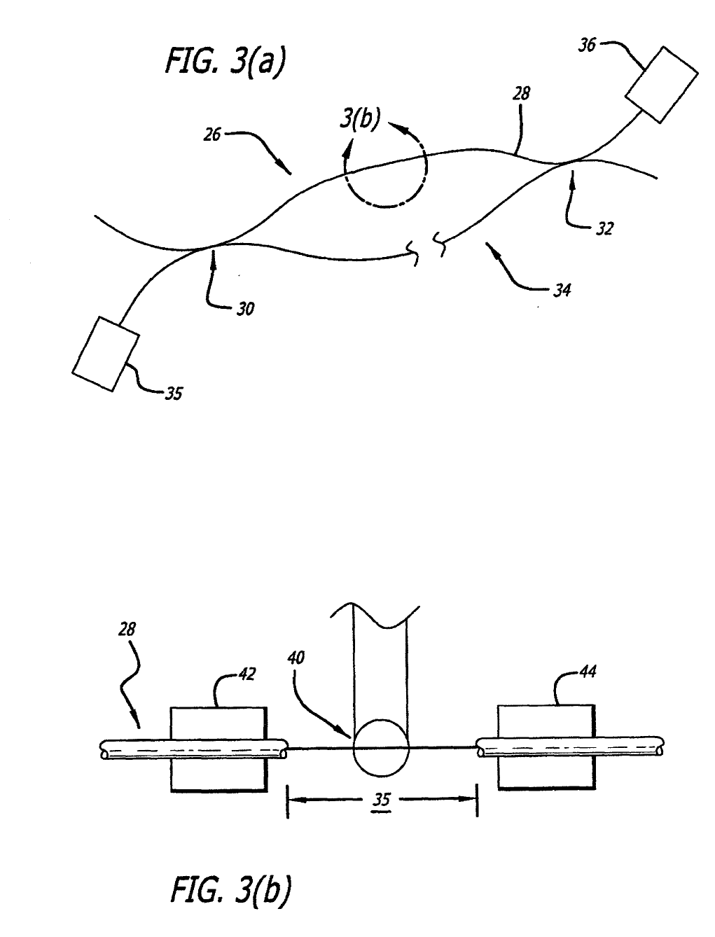

FIGS. 3(a) and 3(b) illustrate an interleaver 26 and a portion of the setup for obtaining a predetermined optical channel spacing by adjusting ΔL in accordance with the method of the invention, respectively. Referring first to FIG. 3(a), the interleaver 26 includes at least one arm 28 comprising a continuous optical fiber. This is formed by fabricating couplers 30 and 32 at predetermined locations along the fiber comprising the arm 28. The other arm 34 may also comprise a continuous optical fiber formed in the same way with the couplers 30 and 32. In the alternative, it may be a composite of discontinuous fiber segments, perhaps spliced together.

By forming the interleaver 26 with at least one arm 28 of a single continuous optical fiber, at least one splice is removed from the optical path between the couplers 28 and 30 and the problem of insertion loss is thereby at least reduced. In theory, it should be analytically possible to form the interleaver 26 with the correct ΔΘ for obtaining a desired spacing between the optical channels of an input DWDM signal (see equation 10). However, due to tolerances, etc., obtaining the correct spacing analytically is often not possible. Moreover, to address this, the invention provides a method for assuring that the all-fiber interleaver 26 will reliably and repeatably achieve the desired optical channel spacing.

DWDM signal source 35, which may comprise, for example, a tunable laser or a plurality of fixed-wavelength lasers, and optical spectrum analyzer 36 are arranged at the input and an output port of the interleaver 26. Such devices are provided for examining the output of the interleaver 26 as it is “fine tuned” during manufacture. FIG. 3(b) illustrates the other portion of the setup of the method of the invention for forming the interleaver 26. As can be seen, the outer jacket is stripped and cleaned from a portion 38 (approximately one inch or less) of the continuous optical fiber comprising the arm 28. The exposed portion 38 is exposed to very high temperature (above 1000 degrees Centigrade) and very localized heating from a hydrogen torch 40 at the same time that a DWDM signal is input from the source 34 and the output observed at the spectrometer 36. Additionally, tension is applied to the heated portion 38 through the controlled separation of vacuum seats 42, 44 which grasp regions of the arm 28 adjacent the stripped portion 38 to stretch the arm 28 until the output observed at the spectrometer 36 indicates that the desired inter-channel spacing has been obtained. It is important to the fabrication of an interleaver in accordance with the invention that the vacuum seats 42, 44 be arranged to grasp the continuous fiber 28 at positions that lie between, rather than outside, the opposed couplers 30 and 32 to prevent the application of tension to the couplers. Such tension force would almost-invariable change the coupling ratios or otherwise degrade the performance of couplers 30, 32 and change the coupling ratio. This would greatly complicate the task of forming an interleaver with precisely-controlled channel spacing.

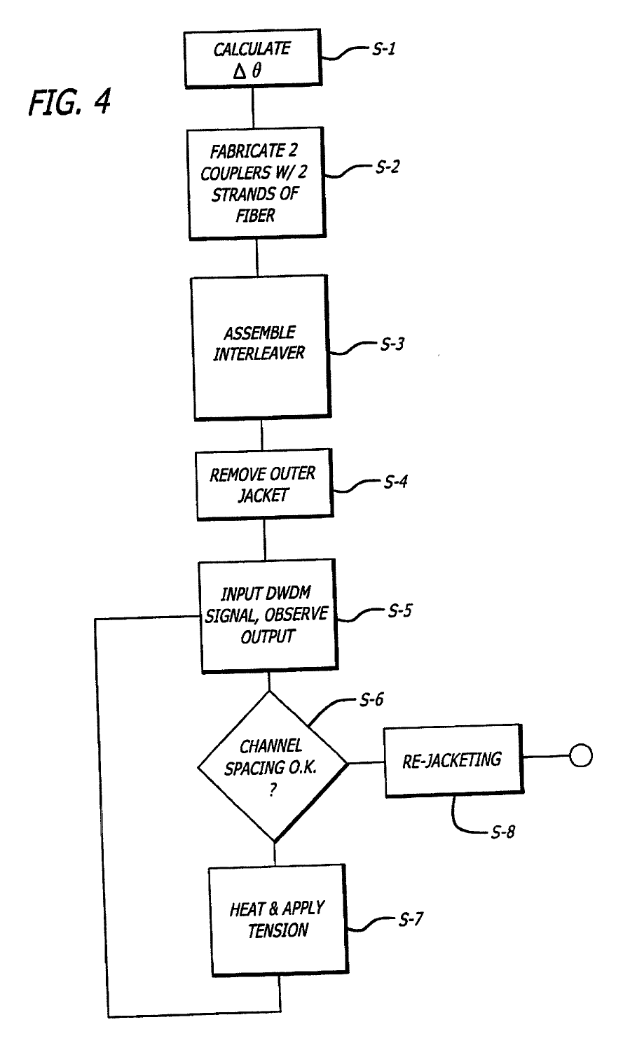

The method of the invention (steps S-1 through S-8) is summarized by the chart of FIG. 4.

Since the method of the invention relies uupon tension, it is essential that the length of the arm 28 comprising a single continuous fiber be no greater than that analytically determined to achieve Δθ. While the application of heat and tension will affect the index of refraction of the fiber in the region of heating and tension, observation of the output of the spectrometer will assure that the proper Δθ is obtained to satisfy the predetermined optical channel spacing.

Thus it is seen that the present invention provides a method for forming an interleaver to assure that a predetermined optical channel spacing is obtained.

While this invention has been described with reference to its presently preferred embodiment, it is not limited thereto. Rather, this invention is limited only insofar as it is described by the following set of patent claims and includes within its scope all equivalents thereof.

What is claimed is:

1. A method for forming an all-fiber optical interleaver of the type that includes a first coupler and a second coupler joined to one another by arms of optical fiber for obtaining a predetermined optical channel spacing comprising the steps of:
a) analytically determining an optical path length difference between a first and second arm of said optical fiber corresponding to said predetermined optical channel spacing; then
b) forming said first arm with the first and second couplers of a continuous optical fiber so that the optical path length of the first arm is equal to or less than said analytically determined optical path length difference from said second arm; then
c) removing the outer jacket for a portion of said continuous fiber intermediate said couplers; then
d) inputting an optical signal comprising a plurality of optical channels to said interleaver; and
e) observing an output of said interleaver; then
f) correcting any difference between the observed optical channel spacing and said predetermined optical channel spacing by applying heat to said portion of said continuous fiber and a tension force to said continuous fiber between locations along said continuous fiber that lie between said couplers; and then
f) repeating steps d through f until said observed output comprises said predetermined optical channel spacing.

2. A method as defined in claim 1 further including the step of applying said heat by means of a hydrogen torch.

3. A method as defined in claim 1 wherein said input signal is a DWDM signal having a predetermined optical channel spacing.

4. A method as defined in claim 1 wherein said output is observed by means of an optical spectrum analyzer.

5. A method as defined in claim 1 wherein a tunable laser is employed to input said optical signal.

6. A method as defined in claim 1 wherein a plurality of fixed-wavelength channels is employed to input said optical signal.

7. An optical interleaver formed by the method of claim 1.
